(19) United States
(12) Patent Application Publication
(10) Pub. No.: US 2017/0347836 A1
(43) Pub. Date: Dec. 7, 2017

(54) SOLID-FUEL COMBUSTION DEVICE HAVING A FUEL RESERVOIR

(71) Applicant: Waldemar REINKE, Fuerth (DE)

(72) Inventor: Waldemar REINKE, Fuerth (DE)

(21) Appl. No.: 15/537,318

(22) PCT Filed: Dec. 18, 2015
(86) PCT No.: PCT/EP2015/080583

§ 371 Date: Jun. 16, 2017

(30) Foreign Application Priority Data
Dec. 19, 2014 (EP) 14199386.5

(51) Int. Cl. A47J 37/07; F23B 20/00; F23B 30/00; F23B 80/00; F23B 50/04

(52) U.S. Cl. CPC A47J 37/0763; F23B 80/00; F23B 50/04; A47J 37/0704; F23B 1/34; A47J 37/0786; F23B 20/00

(57) ABSTRACT

The invention relates to a solid-fuel combustion device, comprising a fuel reservoir for a solid fuel in the form of fuel pieces and a combustion chamber having at least one first opening for the feeding of air and having at least one second opening for the escape of heat and exhaust gases produced when the solid fuel is burned. During proper use, the fuel reservoir is arranged in such a way that the fuel pieces can enter the combustion chamber under the force gravity and can burn there. The fuel reservoir is closed air-tight at least in such a way that no or at least no significant burning can occur in the fuel reservoir during proper use. During proper use, the first opening is arranged below the combustion chamber and the second opening is arranged to the side of the combustion chamber.

The present invention relates to a solid-fuel combustion device having a fuel reservoir.

Solid-fuel combustion devices have been known for many years. These can be operated with different solid fuels such as coal, briquettes, wood or wood pellets. With the typical structure of a solid-fuel combustion device, for example in an embodiment as a grill or oven, the solid fuel burns in a chamber intended for this purpose or on a grate intended for this purpose. Heat and exhaust gases can be conducted away upward. The solid fuel is supplied manually.

Charcoal chimneys are known for accelerating lighting of charcoal for grilling. These are containers, for example composed of aluminum, having a smaller diameter than the container height, into which charcoal is filled, if applicable with lighting accelerants (grill lighters) and in which the entire charcoal is quickly lighted, after charcoal pieces that lie on the bottom are lit by means of a chimney effect, and made to glow.

For a heating system solid fuel boiler, the Internet site http://josef-jobst.de/feststoff discloses a solid fuel boiler, which has a filling shaft above a bed of glowing embers. The fuel slides onto the bed of glowing embers out of the filling shaft, driven by gravity. The gas flow management is structured in such a manner that the air is supplied to the bed of glowing embers from one side of the bed of glowing embers, from above and below, and the resulting low-temperature carbonization gas/air mixture is conducted away again on a side that lies opposite the one side, in such a manner that the main combustion chamber, here a fluidized combustion chamber, lies to the side of the bed of glowing embers.

WO 2008/030566 discloses a heating device for burning pellets, which device has a pellet reservoir and a primary combustion region that lies below it. The primary combustion region is supplied from the reservoir, driven by gravity. Spread of the flames to the reservoir can be prevented by means of an insulation and cooling device. Gas flow management takes place horizontally by means of the primary combustion region. In one embodiment, a covering is provided for the pellet reservoir. A further embodiment provides for a flame barrier above the pellet reservoir.

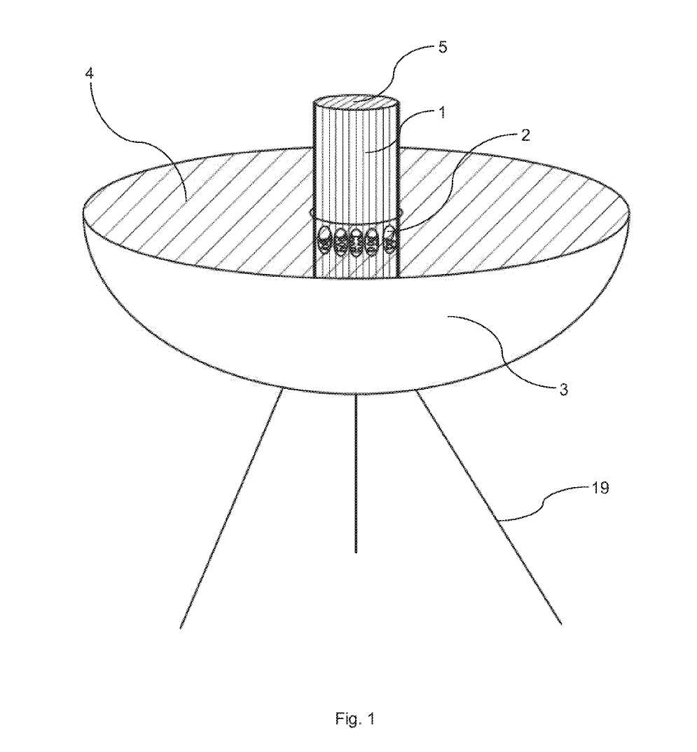

From DE 31 41 694 A1 a boiler for firing solid fuels is known, having a fuel supply that is mounted directly on the material for combustion, in a filling shaft disposed above the grate region, having a closure element that closes the filling shaft off in airtight manner at its upper end. According to FIG. 1 of the document, the filling shaft narrows toward the bottom, and forks in the lower part that leads to the grate region. An air feed is provided from the inside of the forked region to the side of the grate region, while heat and exhaust gases that occur leave the grate region laterally on the opposite side. The structure is relatively elaborate and complicated.

From U.S. Pat. No. 5,251,607 A, a pellet-fired cooking grill is known, in which the pellets fall onto a burner in a burner region by means of gravity. The burner comprises a slanted chute having lateral air openings for inflow of combustion air, and a horizontal platform. Combustion takes place on the slanted part of the chute and the platform. Here, the gas flow management is essentially structured in such a manner that gas flows through the fuel from one side to the other. The structure is relatively complicated, on the whole, and requires a plurality of components.

U.S. Pat. No. 2,653,582 A discloses a solid fuel oven in which the fuel gets onto a grate from a fuel reservoir that has converging side walls, by means of gravity. In this regard, the air required for combustion gets into the combustion region through side walls. The resulting combustion exhaust gases get out of the combustion region through opposite openings in the side walls. The device has a movable grate and water-cooled side walls. It has a relatively complicated structure.

U.S. Pat. No. 2,879,727 A discloses a burner for combustion of sawdust, shredded fuel or similar materials. In this regard, the fuel falls from a charging space onto a throttle grate that stands at a slant and is movably attached, and onto a fixed main grate. The amount of the fuel that gets onto the main grate can be controlled by adjusting the throttle grate. The throttle grate, which is mounted so as to pivot, can easily be cleaned of combustion residues by raising it. This structure is also relatively complicated.

From DE 20 2013 102 333 U1, a burner for solid fuel is known, which has a container for the fuel, which container is provided with a first opening for feed of the solid fuel and a second opening, and comprises a tubular body and a covering element with which the first opening can be hermetically sealed, which element can be removed again. Furthermore, the burner comprises a fire chamber that is connected with the container by means of the second opening and is provided with a third opening for supplying the combustion air and a fourth opening for conducting away the gases produced during combustion. A deflection plate is provided between the container and the fire chamber, with the deflection plate being disposed transverse to the cross-section of the fire chamber and leaving at least one free lateral cavity for controlled feed of fuel into the fire chamber, so that the fuel present in the at least one cavity at a particular time prevents entry of combustion air into the container for the fuel. In this regard, the combustion air is supplied to the fire chamber from the side, and the exhaust gases that occur are conducted away from the fire chamber to the side. This structure is also relatively complicated and tends to become clogged because of the deflection plate and solid fuel that becomes jammed in the lateral cavity. The burner therefore potentially requires maintenance during operation.

From DE 913 099, a slow-combustion insert to be set into the ring opening of solid-fuel range tops is known, which insert consists of a cylindrical vessel that accommodates the fuel supply and can be adjusted above a grate of the range space at an easily adjustable height. For conducting away the smoke gases and low-temperature carbonization gases that form in slow-combustion use, a special exhaust is provided in its interior, for example in the form of a low-temperature carbonization gas exhaust pipe, which opens into the range space. The slow-combustion insert has a lid having a fireproof seal. It can be assumed that in this device, low-temperature carbonization gases get into the slow-combustion insert in that the lid does not close tightly. However, a partial vacuum is created in the slow-combustion insert by means of the low-temperature carbonization gas exhaust pipe, which partial vacuum prevents escape of the smoke gases and low-temperature carbonization gases. The slow-combustion insert is not a solid-fuel combustion device that can be used without a range designed for combustion of solid fuel.

A task of the present invention is indicating a technically simple, advantageous embodiment of a solid-fuel combustion device that guarantees relatively long burning of the solid fuel without solid fuel having to be supplied manually.

This task is accomplished by means of the characteristics of claim 1. Embodiments of the invention are evident from the characteristics of claims 2 to 15.

The invention relates to a solid-fuel combustion device having a fuel reservoir for a solid fuel present in the form of fuel pieces, and a combustion chamber having at least one first opening for air feed and at least one second opening for escape of heat and exhaust gases that occur during combustion of the solid fuel. In this regard, the fuel reservoir is arranged, during proper use, in such a manner that the fuel pieces get into the combustion chamber by means of gravity and can burn up there. In this regard and hereinafter, “during proper use” means that the solid-fuel combustion device is oriented in such a manner as it must be oriented for practical use. In particular, this means that it is oriented in such a manner that the fuel pieces can get into the combustion chamber by means of gravity.

The fuel reservoir is closed off in airtight manner, at least to such an extent that during proper use, no combustion or at least no significant combustion can take place in the fuel reservoir. For this purpose, the fuel reservoir is open downward, toward the combustion chamber, but otherwise closed off in airtight manner, so that no air required for combustion flows into the fuel reservoir, for example by means of a chimney effect. During proper use, the first opening, in each instance, is arranged below the combustion chamber, particularly exclusively, and the second opening is arranged to the side of the combustion chamber. The at least one first opening simultaneously serves for air feed, in this regard, and for allowing solid combustion residues such as ash, for example, to fall out of the combustion chamber. The solid-fuel combustion device according to the invention can thereby be structured in very simple manner and can be produced in cost-advantageous manner. The size of the at least one first opening is directed by the composition and the size of the fuel pieces. It is dimensioned in such a manner that although ash that occurs during combustion of the fuel pieces can fall through, the individual fuel pieces, in each instance, cannot fall through or can fall through the at least one first opening only after they have been burned to a great extent, for example by more than 90 wt.-%. In this way, solid-fuel combustion devices according to the invention can be made available for solid fuels that are present in relatively small pieces.

The combustion chamber and the fuel reservoir are arranged directly one above the other during proper use. In this regard, the fuel reservoir can be arranged perpendicularly above the fuel container. “Directly” particularly means that no spacing and no component such as a fuel feed shaft or a device for regulating fuel feed, for example, is situated between the combustion chamber and the fuel reservoir, which spacing or component delimits the combustion chamber with regard to the fuel reservoir. The combustion chamber differs from the fuel reservoir only by its function, but forms a common space together with the fuel reservoir. The combustion chamber functions as a combustion chamber because air can flow in through the first opening, and heat and exhaust gases that occur during combustion can escape through the second opening. The at least one second opening delimits the combustion chamber in its height. The fuel reservoir begins above the second opening. The fuel reservoir functions as a fuel reservoir because no combustion takes place in it, due to the airtight closure. The combustion chamber and the fuel reservoir can have a common side wall that delimits both the combustion chamber and the fuel reservoir.

In the simplest case, the solid-fuel combustion device according to the invention consists only of the combustion chamber and the fuel reservoir. Such a solid-fuel combustion device can then be suspended only at the top, at the combustion chamber, for example, for operation, so that combustion residues can simply fall to the ground from the at least one opening, or it can be set into a stand designed to hold the solid-fuel combustion device or other device, if applicable with a collection device for combustion residues that exit from the first opening.

In an embodiment of the solid-fuel combustion device according to the invention, which is particularly simple to produce, the fuel reservoir and the combustion chamber have the same cross-sectional surface area in a horizontal cross-section, particularly over the entire height of the combustion chamber and of the fuel reservoir. As a result, the solid-fuel combustion device according to the invention can be produced in simple manner from a pipe that is closed in airtight manner on the one, upper side, and provided, on the other, lower side, with a grate having first openings, and with second openings in the lower region close to the grate. In this regard, the grate can be releasably fixed in place, so that the solid fuel to be burned can be filled into the solid-fuel combustion device by removing the grate.

The solid fuel can consist of coal, charcoal, briquettes, wood chips or solid fuel pressed to form pellets.

The at least one first opening for supplying air to the combustion chamber can be arranged at the bottom of the combustion chamber. The bottom can be structured as a grate that has a plurality of the first openings. The at least one second opening of the combustion chamber for escape of the heat and exhaust gases that occur during combustion of the solid fuel can be arranged in such a manner that a gas stream from the first opening to the second opening is possible. In particular, the second opening lies at the same height as or above the first opening during proper use.

The solid-fuel combustion device can have a plurality of second openings in the combustion chamber, which openings are arranged on multiple sides of the combustion chamber.

During proper use, the combustion chamber can be closed off downward by means of a grate having a plurality of the first openings. The grate can be fixed in place in releasable manner. In this way, it can be removed from the combustion chamber after release of attachment means, for example for cleaning purposes or for refilling the fuel reservoir, from the lower side. It is practical if the first openings of the grate, which closes the combustion chamber off downward, are so small that no or at most small fuel pieces—including pieces that have been partially combusted—can fall through the grate without problems. The ash that forms during combustion of the fuel pieces can be collected in the region of a stand or foot of the solid-fuel combustion device, for example, and removed after operation.

In a simple embodiment of the device according to the invention, the fuel reservoir is firmly closed at the top, for example by means of a lid that is welded on, and the combustion chamber has a grate that is fixed in place in releasable manner at the bottom. In view of the risk of low-temperature carbonization gases that escape, such a device, which is firmly closed at the top, i.e. cannot be opened during normal use and without special tools, is particularly safe. The solid-fuel combustion device can simply be turned upside down to fill it, so that the fuel reservoir is situated at the bottom. The fuel reservoir can be made accessible by releasing the grate, and filled with the fuel pieces. After the grate is subsequently fixed in place, the device can be brought into the orientation for proper use by turning it over. A solid-fuel combustion device structured in this way can be inserted after it is filled, as a cartridge, into an oven holder for accepting such a cartridge, and for burning of the fuel pieces contained in it. For simpler handling, such a cartridge can have a holder handle, particularly on its top. After burning of the fuel pieces contained in the cartridge, the cartridge can be removed from the oven and simply replaced with a further such cartridge, filled with fuel pieces, in order to burn the fuel pieces.

In one embodiment of the solid-fuel combustion device according to the invention, the first opening and the second opening form a common opening, of which a first part serves for air feed to the combustion chamber and a second part serves for escape of the heat and exhaust gases that occur during combustion of the solid fuel, in each instance.

In a further embodiment of the invention, the combustion chamber and the fuel reservoir are composed of a plurality of pieces. As a result, the solid-fuel combustion device according to the invention can be broken down and thereby transported in relatively simple manner. It is also possible that the fuel reservoir and the combustion chamber are produced from one piece. In this way, particularly cost-advantageous production is possible.

In a further embodiment of the solid-fuel combustion device according to the invention, the fuel reservoir is provided with an upper closure. This closure can be structured as a metal sheet that is welded on or as a lid or as a flap. When the lid is removed or the flap is opened, the fuel pieces can be filled into the fuel reservoir. The fuel pieces can be ignited in the combustion chamber when the lid is removed or when the flap is open. Because of the chimney effect that occurs, rapid lighting of the fuel pieces is achieved in the combustion chamber—similar to the charcoal chimneys described above. However, before the fuel pieces ignite in the fuel reservoir, the lid is set on or the flap is closed, and thereby the fuel reservoir is closed again, at least in such airtight manner that during proper use, no combustion or at least no significant combustion can take place in the fuel reservoir. This cancels out the chimney effect.

The fuel reservoir can have at least 1.5 times the height, particularly 2 to 4 times the height, particularly 2 to 3 times the height of the combustion chamber.

In one embodiment of the invention, the solid-fuel combustion device comprises a grill. In this regard, the combustion chamber can be arranged at least partially below a grill grate during proper use. Combustion heat that occurs during operation can heat the food to be grilled, particularly also directly by means of radiation heat. The total height of this embodiment can amount to between 20 and 50 cm. The region below the combustion chamber can be only a few centimeters high in this embodiment. It can comprise a stand structured as a hollow body, having at least one further opening and a foot adapted to the shape of the grill, to increase stability. However, such a foot is not absolutely necessary. Good stability can also be achieved in that the fuel reservoir, with the combustion chamber, projects through an opening in the grill grate that is precisely adapted to it, and is thereby held by the grill grate. Other forms of fixation, for example by means of holding rods, are also possible. Air can get to the first opening through the further opening in the stand. A cross-sectional surface area in a horizontal cross-section through the solid-fuel combustion device can be round or polygonal.

The solid-fuel combustion device according to the invention can also comprise a smoker oven having a smoker chamber or a cooking oven having a cooking chamber. A cooking oven having a cooking chamber in which the food to be cooked is slowly cooked through by means of hot smoke is generally referred to as a “smoker.” In the case of such a cooking oven, the fuel reservoir and the combustion chamber can be arranged outside of the actual cooking chamber and connected with the cooking chamber by means of a heat feed line or smoke feed line or opening. In general, the cooking chamber has at least one combustion gas outlet opening that can be regulated in terms of its size, to allow the smoke to be vented. With such a device, grilled food can be cooked for many hours between 90 and 110° C., for example.

In the case of the cooking oven or the smoker oven, a combustion gas outlet opening, in each instance, for venting the smoke or exhaust gases that occur during combustion of the solid fuel can be provided in the upper region of the housing of the cooking chamber or the smoker chamber, which opening can be regulated in terms of its size. A heat exchanger or heat transfer device, for example in the form of a long, wound stove pipe, can be connected at this combustion gas outlet opening, to give off heat to the room air or to a liquid.

In an alternative embodiment of the invention, the solid-fuel combustion device is structured as a heating stove, particularly one that stands independently. Such a heating stove can be used, for example, to heat a greenhouse. After the combustion chamber has been filled, the stove can give off heat over many hours or even days.

At the at least one second opening, a shunting device having an outgoing line for conducting the heat and exhaust gases that occur can be provided, which apparatus surrounds the at least one second opening and, in the presence of multiple second openings, also collects the resulting heat and exhaust gases. A heat exchanger or heat transfer device for heating room air or for heating water, for example in the form of a long, wound stove pipe, can be connected with the outgoing line.

In another embodiment, the solid-fuel combustion device according to the invention has a stand configured as a hollow body, having at least one further opening. Air can penetrate from the outside through the further opening in the stand and can get to the first opening.

The stove, including a stand, can have a height of 0.5 to 2 m. In the region of the stand, below the further opening, a collection device for ash can be arranged, which can be removed for emptying, for example, or which is accessible by way of a flap that can be opened.

In the following, the invention will be explained in greater detail using exemplary embodiments and drawings.

The figures show:

FIG. 1 a schematic representation of a solid-fuel combustion device according to the invention, comprising a grill,

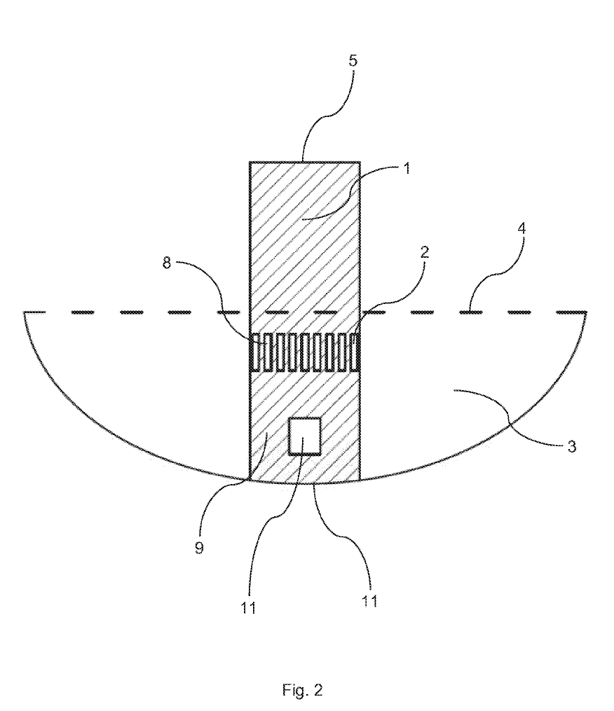

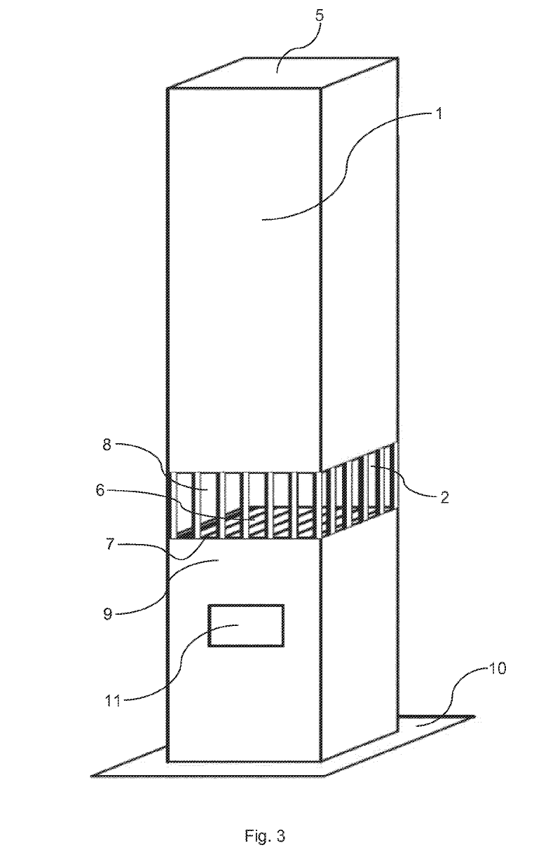

FIG. 2 a schematic cross-sectional representation of the solid-fuel combustion device according to FIG. 1,

FIG. 3 a schematic representation of an embodiment of the solid-fuel combustion device according to the invention as an oven,

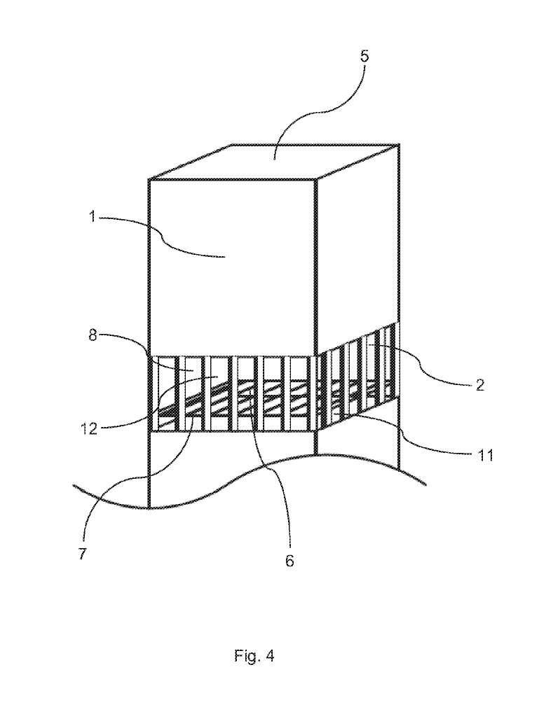

FIG. 4 a schematic representation of a further embodiment of the solid-fuel combustion device according to the invention, having a first and second opening forming a common opening,

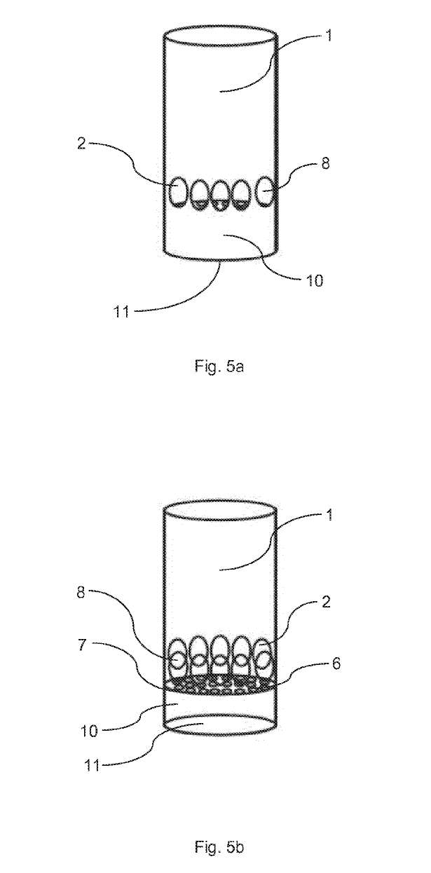

FIGS. 5a, b a schematic representation of a further embodiment of the solid-fuel combustion device according to the invention, having a further opening for air feed that lies below the combustion chamber,

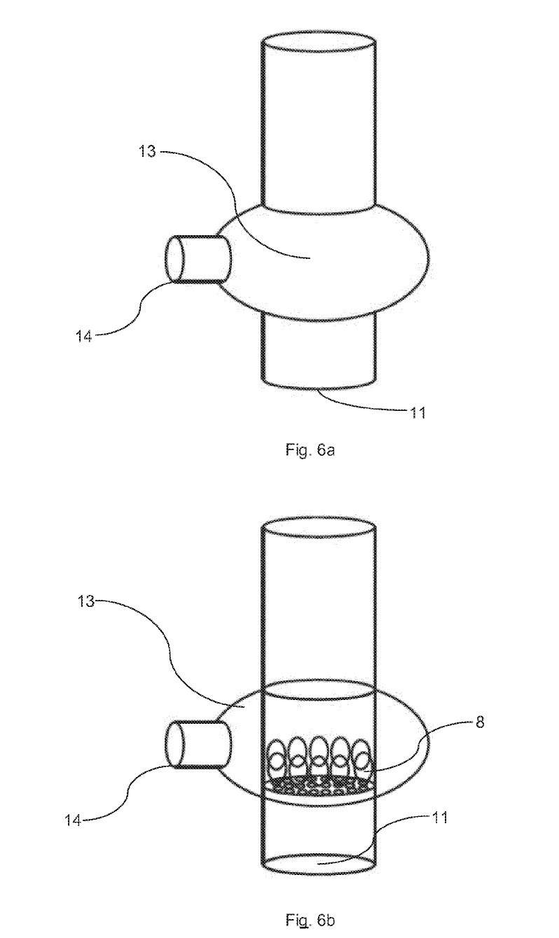

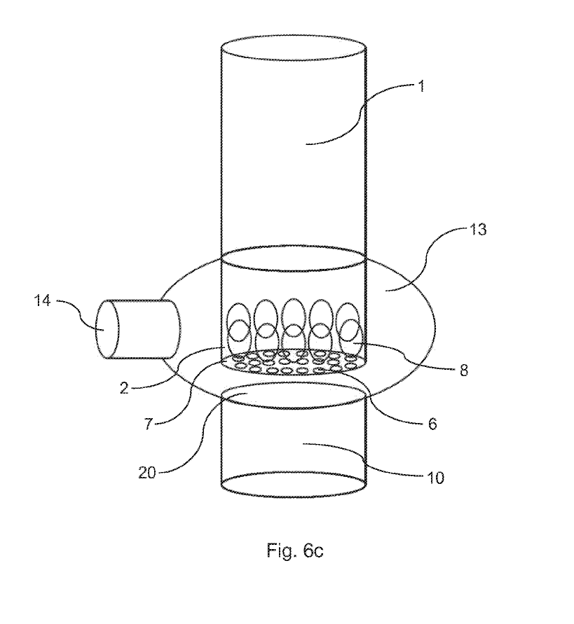

FIGS. 6a, b, c a schematic representation of a further embodiment of the solid-fuel combustion device according to the invention, having a shunting device that surrounds the second openings,

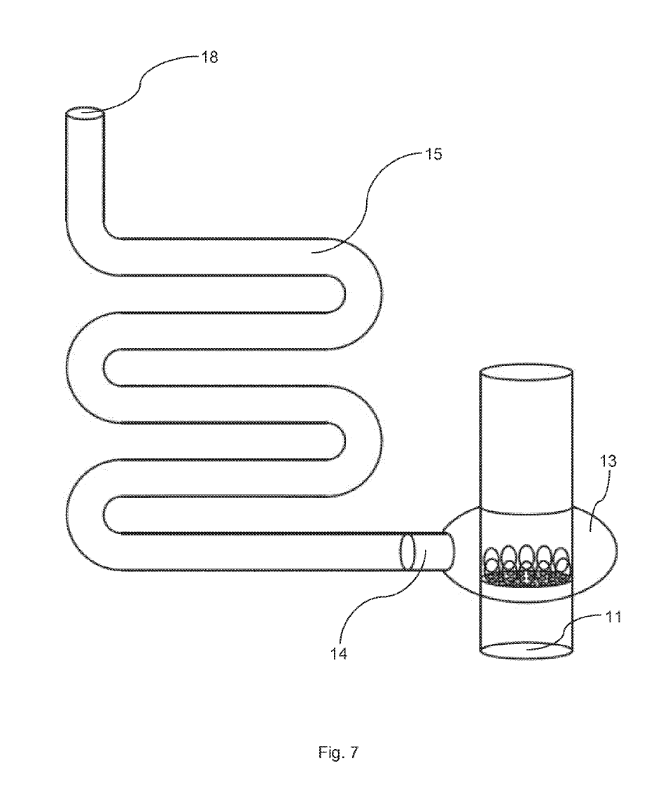

FIG. 7 a schematic representation of a further embodiment of the solid-fuel combustion device according to the invention, having a heat exchanger connected with it,

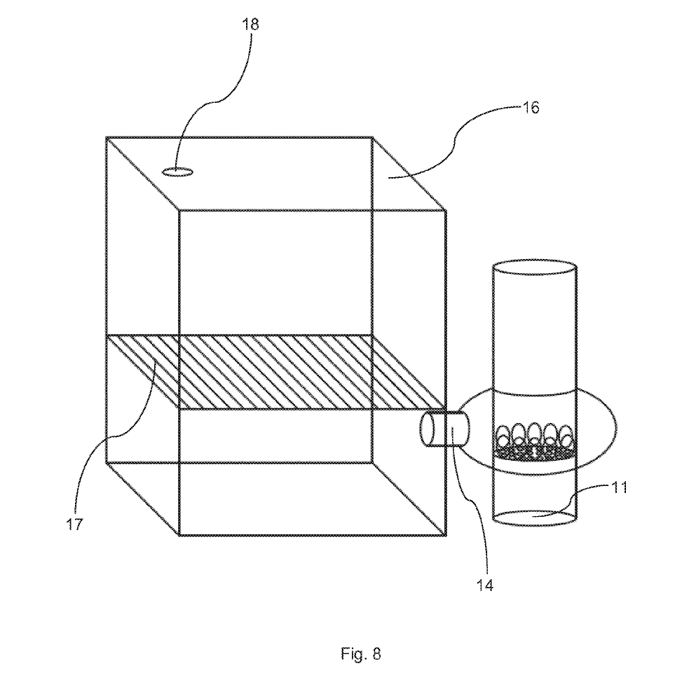

FIG. 8 a schematic representation of a further embodiment of the solid-fuel combustion device according to the invention, having a cooking chamber connected with it, and

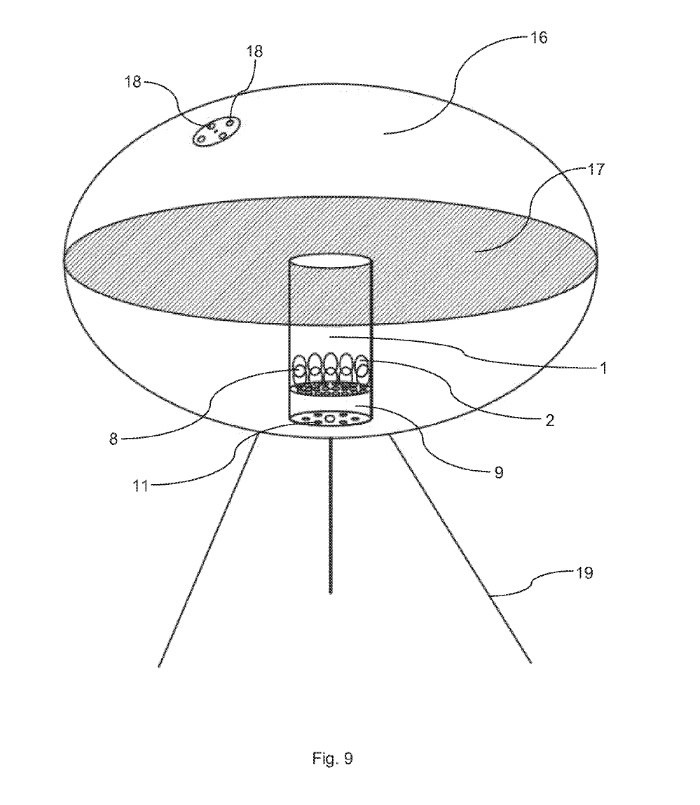

FIG. 9 a further embodiment of a solid-fuel combustion device according to the invention, comprising a cooking chamber.

FIG. 1 shows an embodiment of the solid-fuel combustion device having a fuel reservoir 1 as well as a combustion chamber 2, comprising a grill 3 having three legs 19. The combustion chamber 2 is supplied from the fuel reservoir 1 by means of gravity charging. Here, the combustion chamber 2 lies completely below the grill grate 4, so that combustion heat that flows out of the combustion chamber 2 can be used to heat grilled food. The fuel reservoir 1 is closed off in airtight manner by the upper closure 5, at least to such an extent that during proper use, no significant combustion can take place in the fuel reservoir 1. In particular, the closure 5 is structured in such a manner that no chimney effect occurs in the fuel reservoir 1.

FIG. 2 shows a cross-section of the solid-fuel combustion device according to FIG. 1. The fuel reservoir 1 with closure 5 is arranged above the grill grate 4, while the combustion chamber 2 is arranged below the grill grate 4. During combustion that takes place in the combustion chamber 2, air flows into the combustion chamber 2 through further openings 11 at the side and at the bottom in the stand 9 of the solid-fuel combustion device, which stand is configured as a hollow body, and through first openings 6 in a grate 7, not shown here, which closes off the combustion chamber 2 in a downward direction. The further openings 11 at the bottom of the stand 9 overlap with perforations in the grill 3, not shown here, so that thereby air can flow through the perforations into the further openings 11. The exhaust gases and heat that occur during combustion of the solid fuel get to the outside through second openings 8 on the side of the combustion chamber 2. The second openings 8 can be present on one or more sides of the combustion chamber and can be formed by a grid, for example. It is practical if the second openings 8 surround the entire combustion chamber 2 laterally.

The height of the solid-fuel combustion device can amount to 20 to 70 cm, particularly 30 to 50 cm. In this regard, the height of the fuel reservoir 1 can amount to 15 to 30 cm. The cross-sectional surface area of the solid-fuel combustion device can be round or polygonal in a horizontal cross-section. It is practical if the shape of the cross-sectional surface area in the region of the combustion chamber 2 and of the fuel reservoir 1, and the shape of the grill grate 4 are coordinated with one another, so that no grilled food can fall through between the grill grate 4 and the combustion chamber 2 or the fuel reservoir 1. The diameter of the cross-sectional surface area or the diagonal line through the cross-sectional surface area of the column can amount to 10 to 25 cm.

In the region of the stand 9, below the further opening 11, it is practical if a collection device for ash, not shown here, is affixed, which has an emptying possibility, for example one configured in the form of a flap that can be opened.

FIG. 3 shows an alternative embodiment of the invention as an independently standing heating stove, for example for heating a greenhouse or as a heating stove in a terrace area. The upper closure 5 of the fuel reservoir 1 is structured as a flap that allows refilling of the fuel pieces. The combustion chamber 2 lies below the fuel reservoir 1, so that the fuel pieces of the solid fuel get into the combustion chamber by means of gravity. Air gets into the combustion chamber 2 through first openings 6 in the grate 7, which closes off the combustion chamber from below. Gases that occur due to combustion escape from the combustion chamber 2 through the second openings 8. The second openings 8 are structured as a grid in one or more side walls of the combustion chamber. It is practical if the heating stove comprises a stand 9 structured as a hollow body, which has a further opening 11 through which air can get to the first openings 6. The further opening 11 can have a grid. In order to guarantee stable standing of the solid-fuel combustion device, the stand 9 is provided with a foot 10. Here, the stove is structured as a column having a polygonal cross-sectional surface area in a horizontal cross-section. In this regard, the height of the fuel reservoir 1 amounts to at least 1.5 times the height of the combustion chamber 2. It is practical if the height of the column amounts to between 0.5 and 2 m. The column can be configured in such a manner that it can be separated between stand 9 and combustion chamber 2 or between combustion chamber 2 and fuel reservoir 1 for transport and/or for maintenance purposes.

FIG. 4 shows an alternative embodiment of the air flow management, which is possible both in the embodiment as a grill and in the embodiment as a heating stove. In this regard, further openings 11 and the second openings 8 are each combined with one another in such a manner that common openings 12 are formed. The grate 7 with the first openings 6 contained in it divides these common openings 12 into a region that forms the further openings 11, below the grate 7, and a region that forms the second openings 8, above the grate 7.

FIG. 5a shows a solid-fuel combustion device according to the invention configured as a simple heating stove, for example for operation on a terrace, in an outer view. FIG. 5b shows this solid-fuel combustion device schematically with an outer sheath shown in transparent manner. The solid-fuel combustion device comprises a fuel reservoir 1 and a combustion chamber 2 that is closed off in a downward direction by a grate 7 having first openings 6 contained in it. The combustion chamber 2 has a plurality of second openings 8 for escape of heat and exhaust gases that occur during combustion of the solid fuel. Directly below the grate 7, there is the further opening 11 for inflow of air to the first openings 6, in the foot 10. The fuel reservoir 1 is closed off on its top side.

FIG. 6a and FIG. 6b show a solid-fuel combustion device that corresponds to the device shown in FIGS. 5a and 5b, except for the dimensions, wherein FIG. 6b is a schematic representation of the device shown in FIG. 6a, with the outer sheath shown in transparent manner. The device according to FIGS. 6a and 6b differs from the device according to FIGS. 5a and 5b in that the second openings 8 are surrounded in gastight manner by a shunting device 13 for shunting and collecting the heat and exhaust gases that occur during combustion of the solid fuel. An outgoing line 14 is provided on the shunting device 13 to conduct the exhaust gases away.

FIG. 6c shows an alternative embodiment of the solid-fuel combustion device shown in FIGS. 6a and 6b, with an outer sheath shown in transparent manner. The embodiment differs from the solid-fuel combustion device according to FIGS. 6a and 6b in that the foot 10 is not connected with the combustion chamber 2. The fuel reservoir 1 and the combustion chamber 2 having the grate 7 that has the first openings 6, and having the second openings 8 in the side wall of the combustion chamber 2, already represents a very simple embodiment of the solid-fuel combustion device according to the invention. The shunting device 13 that is additionally present here, with the outgoing line 14 and the foot 10 configured as a hollow body, which is connected with the shunting device 13 by an air feed opening 20 and thereby allows air feed through the foot 10 from below, is actually not required for operation of the solid-fuel combustion device.

FIG. 7 shows the device shown in FIGS. 6a and 6b with a heat exchanger 15 connected with the outgoing line 14. Here, the heat exchanger is shown in the form of a long pipe that can give the heat off to the room air surrounding the heat exchanger, for example. Alternatively, however, such a heat exchanger can also be surrounded by a liquid, so as to heat this liquid. A combustion gas outlet opening 18 is provided at the upper end of the heat exchanger 15, which opening can lead to a chimney, for example, or can itself be structured as a chimney.

FIG. 8 shows the device shown in FIGS. 6a and 6b, in which the outgoing line 14 ends in a cooking chamber 16. The cooking chamber 16 has a cooking grate 17 and a combustion gas outlet opening 18. The combustion gas outlet opening 18 has a regulation device, not shown here, for regulating the size of the passage for the combustion gas. In such a cooking chamber, a food being cooked, for example a large piece of meat, can be cooked over many hours at a relatively low temperature in the combustion gas and in the smoke that forms during combustion. Such cooking is generally referred to as “smoking.”

FIG. 9 shows an alternative embodiment of a cooking chamber 16 having a cooking grate 17, a plurality of combustion gas outlet openings 18 that can be regulated in terms of their throughput, and three legs 19. The fuel reservoir 1 is integrated into the cooking chamber with the combustion chamber 2 and the second openings 8. A stand 9 having a plurality of further openings 11 is arranged below the combustion chamber 2. The further openings 11 in the stand 9 overlap with openings, not shown here, in the bottom of the cooking chamber 16, so that air can get all the way to the first openings 6 in the grate 7, not shown here, through these openings and the further openings 11.

The upper part of the cooking chamber 16 is generally configured as a removable lid, not shown here, in order to be able to lay the food to be cooked onto the cooking grate 17, for example, and to be able to place the solid fuel into the fuel reservoir 1. For this purpose, the fuel reservoir 1 can have a further lid, not shown here, on its top side, which lid is removable but can be closed in airtight manner, to a great extent.

### REFERENCE SYMBOL LIST

1 fuel reservoir
2 combustion chamber
3 grill
4 grill grate
5 closure of the fuel reservoir
6 first opening
7 grate
8 second opening
9 stand
10 foot
11 further opening
12 common opening
13 shunting device
14 outgoing line
15 heat exchanger
16 cooking chamber
17 cooking grate
18 combustion gas outlet opening
19 leg
20 air feed opening

What is claimed is:

1-15. (canceled)

16. A solid-fuel combustion device having a fuel reservoir (1) for a solid fuel present in the form of fuel pieces, and a combustion chamber (2) having at least one first opening (6) for air feed and at least one second opening (8) for escape of heat and exhaust gases that occur during combustion of the solid fuel, wherein the fuel reservoir (1) is arranged, during proper use, in such a manner that the fuel pieces get into the combustion chamber (2) by means of gravity and can burn there, wherein the fuel reservoir (1) is closed off in airtight manner, at least to such an extent that during proper use, no combustion or at least no significant combustion can take place in the fuel reservoir (1), wherein during proper use, the first opening (6) is arranged below the combustion chamber (2) and the second opening (8) is arranged at the side of the combustion chamber (2), wherein the combustion chamber (2) and the fuel reservoir (1), during proper use, are arranged one directly above the other,
characterized in that
the combustion chamber (2) and the fuel reservoir (1) have a common side wall that delimits both the combustion chamber (2) and the fuel reservoir (1).

17. The solid-fuel combustion device according to claim 16, characterized in that the combustion chamber (2) and the fuel reservoir (1) jointly form a space and that no spacing and no component are present between the combustion chamber (2) and the fuel reservoir (1), which spacing or component delimits the combustion chamber (2) relative to the fuel reservoir (1).

18. The solid-fuel combustion device according to claim 16, characterized in that the fuel reservoir (1) and the combustion chamber (2) have the same cross-sectional surface area in a horizontal cross-section.

19. The solid-fuel combustion device according to claim 16, characterized in that the fuel reservoir (1) and the combustion chamber (2) have the same cross-sectional surface area in a horizontal cross-section over the total height of the combustion chamber (2) and of the fuel reservoir (1)

20. The solid-fuel combustion device according to claim 16, characterized in that the combustion chamber (2) has a plurality of second openings (8), which are arranged on multiple sides of the combustion chamber (2).

21. The solid-fuel combustion device according to claim 16, characterized in that the combustion chamber (2), during proper use, is closed off in a downward direction by a grate (7) that is optionally releasably fixed in place and has a plurality of the first openings (6).

22. The solid-fuel combustion device according to claim 16, characterized in that the first opening (6) and the second opening (8) form a common opening (12), of which a first part serves for air feed to the combustion chamber and a second part serves for escape of heat and exhaust gases that occur during combustion of the solid fuel, in each instance.

23. The solid-fuel combustion device according to claim 16, characterized in that the combustion chamber (2) and the fuel reservoir (1) are composed of a plurality of pieces.

24. The solid-fuel combustion device according to claim 16, characterized in that the fuel reservoir (1) and the combustion chamber (2) are produced from one piece.

25. The solid-fuel combustion device according to claim 16, characterized in that the fuel reservoir (1) is provided with an upper closure (5).

26. The solid-fuel combustion device according to claim 16, characterized in that the fuel reservoir (1) has at least 1.5 times the height of the combustion chamber (2).

27. The solid-fuel combustion device according to claim 16, characterized in that the solid-fuel combustion device comprises a grill (3), a cooking oven having a cooking chamber (16) or a smoker oven having a smoker chamber.

28. The solid-fuel combustion device according to claim 16, characterized in that the solid-fuel combustion device is configured as a heating stove.

29. The solid-fuel combustion device according to claim 16, characterized in that a shunting device (13) having an outgoing line (14) is arranged on the at least one second opening (8), which device surrounds the at least one second opening (8) for conducting away the heat and exhaust gases that occur, or, in the case of the presence of multiple second openings (8), also for collecting the heat and exhaust gases that occur.

30. The solid-fuel combustion device according to claim 16, characterized in that the solid-fuel combustion device has a stand (9) configured as a hollow body, having at least one further opening (11) through which air can penetrate from outside and get to the first opening (6).
